(19) United States
(12) Patent Application Publication
(10) Pub. No.: US 2024/0386464 A1
(43) Pub. Date: Nov. 21, 2024

(54) Finite State Machine Based Temporal Path to Purchase Customer Marketing System

(71) Applicant: Redpoint Global Inc., Wellesley, MA (US)

(72) Inventors: Vincent William Porto, Encinitas, CA (US); Jonathan Caplan, Conway, AR (US)

(21) Appl. No.: 18/317,132

(22) Filed: May 15, 2023

(51) Int. Cl. G06Q 30/0251; G06Q 30/0242

(52) U.S. Cl. CPC G06Q 30/0264; G06Q 30/0245; G06Q 30/0246; G06Q 30/0269

(57) ABSTRACT

Embodiments included herein are directed towards a finite state machine based, temporal, path to purchase customer marketing method and system. The method may include generating a plurality of customer focused stimuli, wherein the stimuli include messaging content information, delivery mechanism information, delivery time and frequency information, and message presentation frequency. The method may further include transmitting the plurality of customer focused stimuli to a customer computing device and receiving customer response data in response to the plurality of customer focused stimuli. The method may also include performing response quantization operations on the customer response data within a finite state machine to generate a temporal sequence of personalized customer recommendations.

### BACKGROUND

Electronic commerce has revolutionized the way in which products and services are now acquired and consumed. Providing potential customers with the most appropriate good or service at the most appropriate time and in the most appropriate manner is a constant struggle. Virtually all existing recommendation engines utilize a technique called collaborative filtering that only considers a single point-in-time. Behavioral science has long known that effecting a desired behavioral response (i.e., end goal) most often requires multiple, sequential stimuli. In the simplest case, it may be possible to repeatedly present identical stimuli, using the identical delivery mechanism over some period of time. However, given the variance in human behaviors, and complex, dynamically changing environments we live in, this provides sub-optimal results.

### SUMMARY

In one or more embodiments of the present disclosure, a finite state machine based temporal path to purchase customer marketing method is provided. The method may include generating, using a processor, a plurality of customer focused stimuli, wherein the stimuli include messaging content information, delivery mechanism information, delivery time and frequency information, and message presentation frequency. The method may further include transmitting the plurality of customer focused stimuli to a customer computing device and receiving customer response data in response to the plurality of customer focused stimuli. The method may also include performing response quantization operations on the customer response data within a finite state machine to generate a temporal sequence of personalized customer recommendations.

One or more of the following features may be included. In some embodiments, the finite state machine may include a training phase, an updating phase, and/or a prediction phase. Each of the plurality of customer focused stimuli may be transmitted at different timepoints. The customer response data may be received at different timepoints. The finite state machine may receive a desired end goal as an input from a business entity.

In another embodiment of the present disclosure, a non-transitory computer readable storage medium having stored thereon instructions, which when executed by a processor result in one or more operations is provided. Operations may include generating, using a processor, a plurality of customer focused stimuli, wherein the stimuli include messaging content information, delivery mechanism information, delivery time and frequency information, and message presentation frequency. Operations may further include transmitting the plurality of customer focused stimuli to a customer computing device and receiving customer response data in response to the plurality of customer focused stimuli. Operations may also include performing response quantization operations on the customer response data within a finite state machine to generate a temporal sequence of personalized customer recommendations.

One or more of the following features may be included. In some embodiments, the finite state machine may include a training phase, an updating phase, and/or a prediction phase. Each of the plurality of customer focused stimuli may be transmitted at different timepoints. The customer response data may be received at different timepoints. The finite state machine may receive a desired end goal as an input from a business entity.

In one or more embodiments of the present disclosure, a system for finite state machine based temporal path to purchase customer marketing is provided. The system may include a computing device having at least one processor and a memory, wherein the at least one processor is configured to generate, using a processor, a plurality of customer focused stimuli, wherein the stimuli include messaging content information, delivery mechanism information, delivery time and frequency information, and message presentation frequency. The at least one processor may be further configured to transmit the plurality of customer focused stimuli to a customer computing device and to receive customer response data in response to the plurality of customer focused stimuli. The at least one processor may be further configured to perform response quantization operations on the customer response data within a finite state machine to generate a temporal sequence of personalized customer recommendations.

One or more of the following features may be included. In some embodiments, the finite state machine may include a training phase, an updating phase, and/or a prediction phase. Each of the plurality of customer focused stimuli may be transmitted at different timepoints. The customer response data may be received at different timepoints. The finite state machine may receive a desired end goal as an input from a business entity.

Additional features and advantages of embodiments of the present disclosure will be set forth in the description which follows, and in part will be apparent from the description, or may be learned by practice of embodiments of the present disclosure. The objectives and other advantages of the embodiments of the present disclosure may be realized and attained by the structure particularly pointed out in the written description and claims hereof as well as the appended drawings.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 diagrammatically depicts a recommendation process coupled to a distributed computing network;

FIG. 2 depicts a flowchart showing an example recommendation process consistent with embodiments of the present disclosure;

FIG. 3 depicts a diagram consistent with embodiments of the present disclosure;

FIG. 4 depicts a diagram consistent with embodiments of the present disclosure;

FIG. 5 depicts an example finite state machine training algorithm consistent with embodiments of the present disclosure;

FIG. 6 depicts an example finite state machine updating algorithm consistent with embodiments of the present disclosure;

FIG. 7 depicts an example finite state machine prediction algorithm consistent with embodiments of the present disclosure;

FIG. 8 depicts an example path to purchase finite state machine consistent with embodiments of the present disclosure;

FIG. 9 depicts an example showing all potential paths and a number of timepoints consistent with embodiments of the present disclosure;

FIG. 10 depicts an example showing an optimized temporal sequence consistent with embodiments of the present disclosure;

FIG. 11 depicts an example showing finite state machine node stimulus-response transitioning consistent with embodiments of the present disclosure;

FIG. 12 depicts an example showing finite state machine node feature quantization equivalency consistent with embodiments of the present disclosure;

FIG. 13 depicts an example showing finite state machine node demographic feature quantization equivalency consistent with embodiments of the present disclosure;

FIG. 14 an example showing finite state machine node stimulus feature quantization equivalency consistent with embodiments of the present disclosure;

FIG. 15 an example showing finite state machine node response feature quantization equivalency consistent with embodiments of the present disclosure;

FIG. 16 depicts an example showing a sample customer to finite state machine node demographic mapping consistent with embodiments of the present disclosure;

FIG. 17 depicts an example showing a sample customer to finite state machine node stimulus mapping consistent with embodiments of the present disclosure;

FIG. 18 depicts an example showing a sample customer to finite state machine node response mapping consistent with embodiments of the present disclosure;

FIG. 19 depicts an example showing a finite state machine node graph with transition linkages consistent with embodiments of the present disclosure;

FIG. 20 depicts an example showing all possible paths to a desired end goal consistent with embodiments of the present disclosure;

FIG. 21 depicts an example showing a shortest path to a desired end goal consistent with embodiments of the present disclosure;

FIG. 22 depicts an example showing a lowest cost path to a desired end goal consistent with embodiments of the present disclosure;

FIG. 23 depicts an example showing a highest probability path to a desired end goal consistent with embodiments of the present disclosure; and

FIGS. 24-29 depict example graphical user interfaces consistent with embodiments of the present disclosure.

### DETAILED DESCRIPTION

As discussed above, virtually all existing recommendation engines utilize a technique called collaborative filtering which attempts to utilize the information from other customers that is deemed sufficiently similar to generate predictive recommendations. The computational complexity of collaborative filtering results in large CPU and memory requirements, leading to long training times and often unrealistic limits on the size of the applicable feature space. Accordingly, embodiments of the recommendation process described herein may avoid these requirements by generating a temporal sequence of personalized recommendations for products, offers, messaging, etc. as a sequence of stimuli generated by a Finite State Machine (FSM). In some embodiments, demographics, behaviors, and previous messaging (e.g., stimulus-response pairs) may be used to generate and maintain an FSM that may be dynamically updated through time. In some embodiments, the recommendation process described herein provides a way to encapsulate and describe the probabilistically optimal set of messages as a sequence of stimuli, and dynamically update the state of each customer as their responses are collected. End goals may be identified that allow back-chaining to obtain the highest probability messaging sequences with the highest probability of achieving the goal(s). To limit the recommendation process to a computationally tractable system, state information may be quantized to allow a finite number of states. Operational constraints may be placed on the algorithm running parameters such that the system performs predictions, updates, and analysis within available computational resources.

Reference will now be made in detail to the embodiments of the present disclosure, examples of which are illustrated in the accompanying drawings. The present disclosure may, however, be embodied in many different forms and should not be construed as being limited to the embodiments set forth herein; rather, these embodiments are provided so that this disclosure will be thorough and complete, and will fully convey the concept of the present disclosure to those skilled in the art. Like reference numerals in the drawings denote like elements.

### System Overview

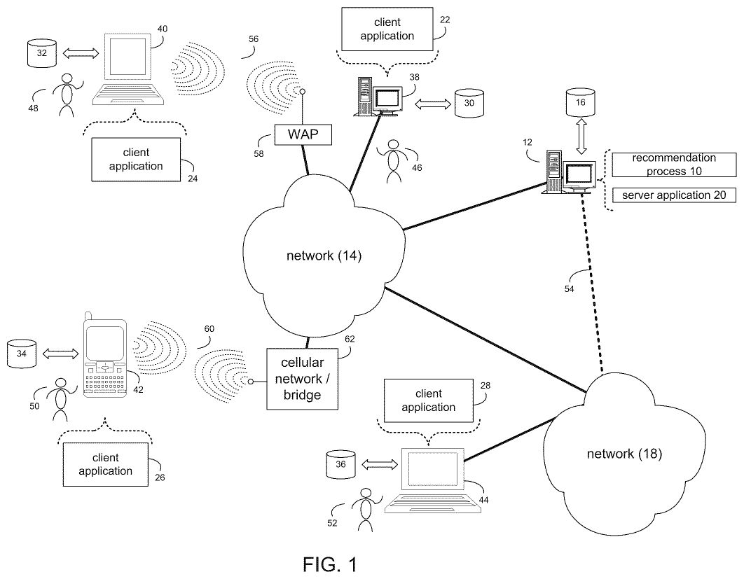

Referring to FIG. 1, there is shown a recommendation process 10 that may reside on and may be executed by server computer 12, which may be connected to network 14 (e.g., the internet or a local area network). Examples of server computer 12 may include, but are not limited to: a personal computer, a server computer, a series of server computers, a minicomputer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally, and/or alternatively, recommendation process 10 may reside on a client electronic device, such as a personal computer, notebook computer, personal digital assistant, or the like.

The instruction sets and subroutines of recommendation process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random-access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Microsoft Exchange™ Server. Server application 20 may interact with one or more client applications (e.g., client applications 22, 24, 26, 28) in order to execute recommendation process 10. Examples of client applications 22, 24, 26, 28 may include, but are not limited to, design verification tools such as those available from the assignee of the present disclosure. These applications may also be executed by server computer 12. In some embodiments, recommendation process 10 may be a stand-alone application that interfaces with server application 20 or may be applets/applications that may be executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition/as an alternative to being server-based applications residing on server computer 12, recommendation process 10 may be a client-side application residing on one or more client electronic devices 38, 40, 42, 44 (e.g., stored on storage devices 30, 32, 34, 36, respectively). As such, recommendation process 10 may be a stand-alone application that interface with a client application (e.g., client applications 22, 24, 26, 28), or may be applets/applications that may be executed within a client application. As such, recommendation process 10 may be a client-side process, server-side process, or hybrid client-side/server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, recommendation process 10 may be a cloud-based process as any or all of the operations described herein may occur, in whole, or in part, in the cloud or as part of a cloud-based system. The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, Apple IOS, ANDROID, or a custom operating system.

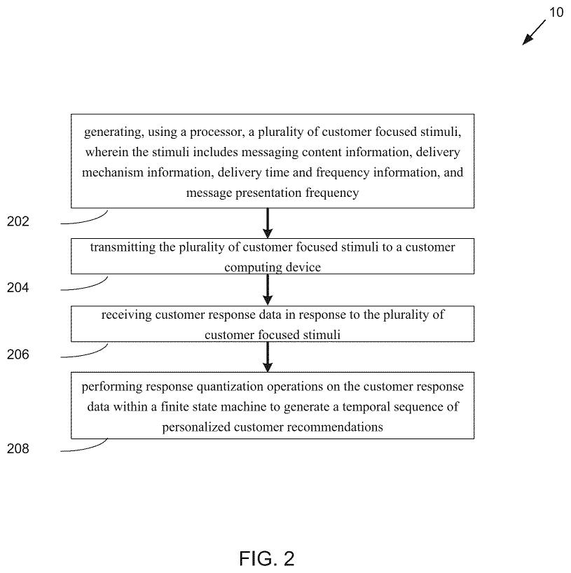

Referring now to FIG. 2, a flowchart showing one or more operations consistent with embodiments of recommendation process 10 is provided. The method may include generating (202), using a processor, a plurality of customer focused stimuli, wherein the stimuli include messaging content information, delivery mechanism information, delivery time and frequency information, and message presentation frequency. The method may further include transmitting (204) the plurality of customer focused stimuli to a customer computing device and receiving (206) customer response data in response to the plurality of customer focused stimuli. The method may also include performing (208) response quantization operations on the customer response data within a finite state machine to generate a temporal sequence of personalized customer recommendations. Numerous additional operations are also within the scope of the present disclosure, which are discussed in further detail hereinbelow.

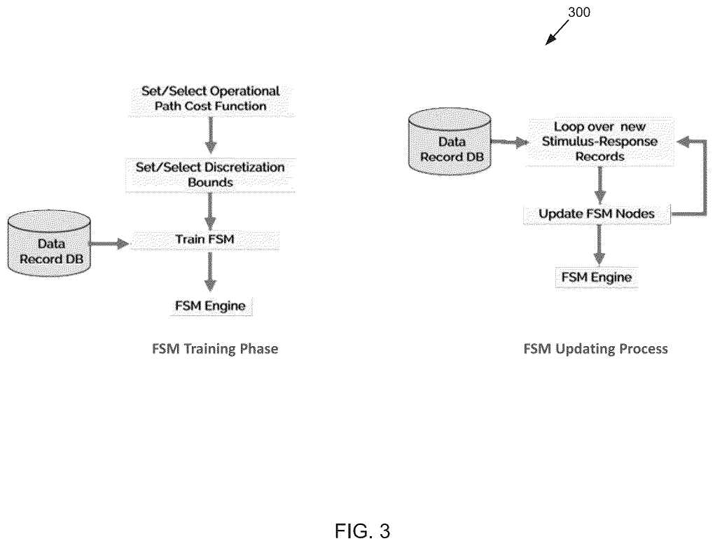

Referring now to FIGS. 3-29, additional diagrams consistent with embodiments of recommendation process 10 are provided. Embodiments of recommendation process 10 present an approach for generating a temporal sequence of personalized recommendations for products, offers, messaging, etc. as a sequence of stimuli generated by a Finite State Machine (FSM). In some embodiments, demographics, behaviors, and/or previous messaging (e.g., stimulus-response pairs) may be used to generate and maintain an FSM that is dynamically updated through time. Recommendation process 10 provides an approach to encapsulate and/or describe the probabilistically optimal set of messages as a sequence of stimuli, and dynamically update the state of each customer as their responses are collected. End goals may be identified that allow back-chaining to obtain the highest probability messaging sequences with the highest probability of achieving the goal(s). In an effort to generate a computationally tractable system, state information may be quantized to allow for a finite number of states. Operational constraints may be placed on one or more running parameters such that recommendation process 10 performs predictions, updates, and analysis within available computational resources.

In some embodiments, recommendation process 10 may be used in any suitable application, some of which may include, but are not limited to, 1) replacement or augmentation of singleton-point-in-time recommendation engines, 2) provision for temporal analysis of marketing campaign success, 3) identification of favorable and unfavorable marketing path sequences, 4) insightful “short, medium, and long-term” analysis facilitating specification of multi-dimensional (and sequential) business goals, etc. Additionally, and/or alternatively, recommendation process 10 may be used in conjunction with fully and semi-automated directed campaign systems, preference modeling, and/or tailored-feedback systems for new product development, and customer relationship optimization.

As discussed above, common predictive/proscriptive messaging approaches focus on a single point-in-time message and neglect the fact that behaviors are usually influenced over time via multiple, tailored, sequences of messages. Behavioral psychologists have long known that humans (and other species) form opinions and demonstrate behaviors (e.g., responses) based on sequential stimuli (e.g., multiple, temporal message stimuli). This is especially true for establishing marketplace brand loyalty, long term purchases (i.e., automobiles), and consumable influencing. The application of a finite-state machine (FSM) that reflects the probabilistic state transitions enables marketing professionals to think about the tailored ‘path-to-end-goal’, instead of limiting themselves to a single point-in-time approach. Temporal sequencing is analogous to the game of pool wherein the shot choice is selected to set up the ball for the next shot, then the next, etc. While the end goal is to sink the eight ball, optimizing the sequence and placement provides the best chance of achieving this result in a competitive situation. In addition, since the FSM may be analyzed and queried for alternative (e.g., pareto-optimal) paths, it May 1) provide insight into “what-if” scenarios, and 2) facilitates incorporation of dynamically changing goals if/as the needs of the business changes over time. The probabilistic nature of the FSM transitions more closely mirrors real-life responses to stimuli when compared to absolutely proscriptive, single-point-in-time algorithms.

In some embodiments, recommendation process 10 may include a temporal path to purchase methodology that uses FSM predictive modeling. This approach may allow for tailoring both the stimulus (e.g., message content), delivery mechanism (e.g., channel), and timing to optimize response rates. This may be modeled as an FSM. State machines are abstract computational logic models in which tasks (e.g., data and behaviors) transition from one state to another, producing actions as part of the transition process. In the context of a state machine, the concept of “state” is a representation of descriptive information along with current and past stimuli and responses to those stimuli. State machines typically contain multiple distinct states (e.g., nodes in a graph), each of which may have transition paths to another state. The state machine accepts a stimulus (e.g., message), and produces an output response (e.g., purchase product). State transitions occur when stimuli are sufficient to change from one state in the machine to distinctly different state.

In some embodiments, the phrase FSM, as used herein, may refer to a state machine having a finite number of states (e.g., nodes) and finite number of transitions, making them computationally tractable for use in predictive modeling. Within the marketing environment, a state might include demographic data, personal data, as well as previous behavioral responses to stimuli (e.g., message-response pairs).

In some embodiments, a node in the state machine may represent a customer that has similar descriptive information and similar set(s) of stimulus-response pairs. Quantization may be used to reduce the potentially infinite number of customer states to a reasonable number for operational use. The FSM associated with recommendation process 10 may include a graph with nodes, and links (e.g., transitions) to other nodes in the graph. This FSM graph may be cyclic or acyclic depending on the data presented to it during training and subsequent updating processes. Nodes in this FSM graph may represent the discretized customer record data, with transition links to other nodes. Transitions may utilize probabilities generated by tracking the number and frequency of transitioning from one (quantized) node state to another (quantized) node state based on stimuli-response data.

In some embodiments, each stimulus (e.g., message) may be tailored to drive the subject to a desired behavioral state (e.g., response). Stimuli may include, but is not limited to, one or more of 1) messaging content (including, but not limited to text, graphics, still and/or motion video, colors, scents, sounds), 2) delivery mechanism(s) (including, but not limited to email, text messaging, visual advertisements from/on search engine pages, direct mail, loudspeaker, television, social media, billboard signage, apparel, and 3) delivery time and frequency information (e.g., time of day, day, week, month, etc. along with 4) message presentation frequency (e.g., singleton instance, once per week, hourly).

In some embodiments, stimuli may be created by a company and/or advertiser, prior to creating/using the FSM to present various pertinent information to their clients. Stimuli may be updated over time to keep up with product changes, marketing goals, customer trends, etc.

In some embodiments, responses may be quantized (e.g., categorized) into appropriate, trackable information gathered from customers after presentation of stimuli. As with quantization of stimuli, response quantization provides the ability to turn potentially infinite state machines into a computationally tractable number of finite states. Responses may include categories such as “no response”, “clicked on link”, “expressed disinterest”, “purchased product/service”, “repeated purchase”, and “viewed website materials”. Responses may also be gathered from third-party sources if/as available, analysis of social media information (e.g., trends, queries, click-throughs), or pre/post messaging customer survey or research company information.

In some embodiments, one or more nodes in the FSM may utilize this quantization strategy to ingest data records into nodes with individual parameters that have lower and upper limit ‘bounds’ (e.g., number of times presented with stimulus Y must be in the range [1,4], inclusive. During training or updating, processing a data record may update node parameter values dynamically (e.g., increment the value of number of presentations of stimulus Y). When the node bounds are exceeded, the state transitions to (or creates) a new node updating its parameter values if/as necessary. Specification of these bounds provides the ability to maintain computationally tractable memory and throughput speeds. Lowering the range of specific bounds allows for the FSM to represent more fine-tuned behaviors, whereas larger parameter bound ranges result in lower memory and processing requirements.

In some embodiments, recommendation process 10 may include a training process. Training may be accomplished by processing one or more data records sequentially. Each data record (e.g., a temporally sorted sample of customer demographics, messaging stimuli, behavioral response) may be presented to recommendation process 10, which May 1) identify which node may be closest to the record, 2) update the node contents, 3) update the state transition probabilities, and/or 4) transition the customer record to the next node if/as required per the transition probability status. In some embodiments, identifying the closest node may be performed with a function that calculates the distance between the customer record and the information in the node. This function may include, but is not limited to, weighted least edit distance, full equality comparison, discretized (bin placement) equality, or any other suitable distance measure or metric. New nodes may be created and added to the FSM graph and if no node exists that is close to the customer record, a new node may be created with initialized transition probabilities and added to the FSM. If there is a closest node identified per the quantized data, but the response is not contained within the set of current responses to this pre-existing node, the existing ‘closest’ node is updated to contain the new response. If there is no closest node found, a new node may be created containing this single response. In all cases, any/all existing response probabilities may be re-adjusted (normalized) to account for the addition of new response information.

In some embodiments, updates associated with recommendation process 10 may be performed by presenting new stimulus-response data to the FSM as it becomes available. Updating may be functionally similar to the training process. Accordingly, after training, each new data record containing a stimulus-response pair (e.g., customer demographics, latest messaging info, response to the message) may be passed into the FSM. The FSM may be searched for the closest node, and the information in that node may be updated. Transition probabilities may be updated using one of various methodologies (e.g., Bayesian, Null Hypothesis Statistical Testing, basic averaging). This consists of updating the quantized data as well as the transition probabilities. New nodes may be added as necessary in the same manner as in the training phase.

In some embodiments, prediction associated with recommendation process 10 may represent the process of identifying where the customer record exists in the trained FSM graph (e.g., find the ‘closest’ node), and where the transition probabilities are likely to move the record to the desired end goal (e.g., generate the desired response) given the presentation of one or more sequentially-linked stimuli. Prediction may be performed in using a variety of different approaches. For example, 1) given a data record (e.g., customer demographic info with behavioral stimulus-response history) search for the closest node in the FSM (e.g., designated as point A in the FSM graph), 2) given the objective goal (e.g., desired end result response), search the FSM for the node containing the desired response state (e.g., designated as point B in the FSM graph), and 3) find the set of all paths, designated as set of nodes {S} from the closest node point A to point B, 4) using the designated path cost function, calculate the distance of all unique paths in set {S}. 5) sort and rank all paths in set {S}. 6) select the path (designated {S-optimal}) with the highest scoring path (e.g., lowest number of links, lowest overall messaging cost, highest end-state profitability, highest probability of reaching the end state) as the temporal sequence of messages (with times, channels, etc.) to generate and present to the end consumer (e.g., customer). In some embodiments, the results of presenting each message (e.g., stimulus-response pairs) may be used to update the FSM afterwards to maintain currency. This process may be performed on each unique data record for which predicting the optimal sequential messaging path is desired.

In some embodiments, a single step in the selected sequence from set {S} above may be equivalent to most current messaging methodologies (e.g., only predicting one step at a time), and largely ignores the tendency for human behavior to be influenced over a period of time via multiple stimuli. Embodiments of recommendation process 10 presents an enhanced ability to predict and act upon multiple, sequential optimized, individually tailored steps based on probabilistic data contained within the FSM.

In some embodiments, recommendation process 10 may operate based upon one or more basic functional inputs. Some of which may include, but are not limited to, customer data (e.g., demographics, previous behaviors, responses to message stimuli), messaging information (e.g., describing products, services, capabilities, text, colors, olfactory and/or auditory information, video displays), message distribution channel and timing options, etc. In operation recommendation process 10 may select the appropriate function calculating the distance (e.g., closest) between an input data record and the nodes in the FSM. It should be noted that typical implementations provide multiple distance functions such that the user only needs to choose from a list, with the option of creating a custom distance function. Recommendation process 10 may select the appropriate end-goal cost function to calculate the path lengths between any two points A and B in the FSM. It should be noted that typical implementations provide multiple cost functions such that the user only needs to choose from a list, with the option of creating a custom distance function.

In some embodiments, recommendation process 10 may provide one or more prediction outputs. A prediction output may include a (sequentially optimized) set of product/offer/service messages, tailored to probabilistically drive the prospective customer to the desired end response state (e.g., take action to purchase a product). In some embodiments, the end user may not be restricted to perform all messaging (stimuli) steps in the sequence, and, as desired, may choose to utilize a subset for specific customers (e.g., steps 1, 2, and 3 in a sequence of 5 steps). All information regarding the stimuli in set {S-optimal} is made available for subsequent analysis, review, recording, and/or other post-prediction processes.

In some embodiments, recommendation process 10 may utilize one or more state variables. These may include, but are not limited to, basic demographic information, survey results, preferences, loyalty club data, etc. as read from one (or more) column(s) from a data source. Expected/acceptable field types may include, but are not limited to, text, numeric, and/or potentially binary data. At least one data field column may be designated for state variables. In some embodiments, recommendation process 10 may include a graphical user interface that may include a dropdown menu to select from one or more of the existing input data columns from a designated data source.

In some embodiments, recommendation process 10 may utilize one or more stimulus variables. These may include, but are not limited to, basic messaging information (e.g., advertisements, offers, emails, text messages, etc.), as read from one (or more) column(s) from a data source. Each stimulus message may be unique and either mapped to existing content (e.g., colors, discounts, pictures, text), or contain the actual textual information in each data field element. Stimulus messages may be unique (or mapped to a unique key that has been selected in another associated column). Some expected/acceptable field types may include, but are not limited to, text, numeric, and potentially binary data. In some embodiments, at least one data field column may be designated for stimulus (message) variables. Message content (as uniquely mapped) may be with respect to content that has been previously presented to a customer, and/or may also be presented to a customer as a future ad/offer/message. In some embodiments, recommendation process 10 may include a graphical user interface that may include a dropdown menu to select from one of the existing input data columns from the designated data source. It should be noted that the data source may be different from that used to access state and other variables.

In some embodiments, recommendation process 10 may utilize one or more response variables. These may include, but are not limited to, basic responses (e.g., ‘hit landing page’, ‘filled shopping cart’, ‘completed purchase’, ‘no response’) to previous stimuli (messages). These responses may be read from one (or more) designated column(s) from a data source. Each response should be unique. Response content should be unique (or mapped to a unique key present in another selected column). Some expected/acceptable field types may include, but are not limited to, text, numeric, and potentially binary data. In some embodiments, at least one data field column may be designated for response variables. Responses (as uniquely mapped) may represent previous and future expected responses that correlate (d) with messages presented to a customer. In some embodiments, recommendation process 10 may include a graphical user interface that may include a dropdown menu to select from one of the existing input data columns from the designated data source. It should be noted that the data source may be different from that used to access state and other variables.

In some embodiments, recommendation process 10 may utilize one or more goal (e.g., end-state) variables. Accordingly, recommendation process 10 may include a selection of at least one of the responses from the set of responses (e.g., extracted from the actual response data). This may include 1) first reading response data (from the response variables data source), 2) extracting the set of unique responses and populating a list, and/or 3) selecting one or more responses from this list to serve as the end-state goals. Additional goal variables may include one or more options to select one or more goals from a list. For example, maximize probability of purchase (default), minimize time/steps to purchase (default), maximize overall profit, maximize customer loyalty, etc. Each of the additional goal variables will have a user-configurable weight associated with it in the graphical user interface. Some expected/acceptable field types may include, but are not limited to, text, numeric, and potentially binary data. In some embodiments, at least one data field column may be designated for goal variables. Goals (as must represent previous and future expected responses that correlate (d) with messages presented to a customer. At least one of the additional goal variables may be selected. In some embodiments, recommendation process 10 may include a graphical user interface that may include a dropdown menu to select goals from one of the sets of unique responses as read from the data in the designated response column(s). Weight selection via movable horizontal/vertical scroll bars may be used to minimize customer confusion and may be internally translated into numeric values in a specific range (e.g., [0.0, 1.0]).

In some embodiments, recommendation process 10 may include customer record data. This may include, but is not limited to, customer demographic data, as well as the set of stimulus/response information previously presented to the customer. Demographic data may correspond to the same field types/content as designated in the state variables (e.g., name, value pairs). Stimulus/response data may include the message, response, and messaging channel (e.g., twitter, email, facebook, app push), and time/date stamp. In operation, the user may be able to select a data source that includes these types of data, including column headers that map directly to the column names selected for state, stimulus, and response data. In some embodiments, the customer data source may include one or more of expected/acceptable input, filename, database name, etc. In some embodiments, recommendation process 10 may include a graphical user interface that may include a windows menu to select from a list of files, databases, etc.

Referring again to FIG. 3, a diagram 300 showing an example temporal path to purchase FSM operational flow consistent with embodiments of recommendation process 10 is provided. Depicted in FIG. 3 are the process flows for 1) setting up the initial training parameters (e.g., optimization goal, discretization bounds, input sources) together with training with initial data sets, and 2) updating the trained FSM with additional data if/as it becomes available.

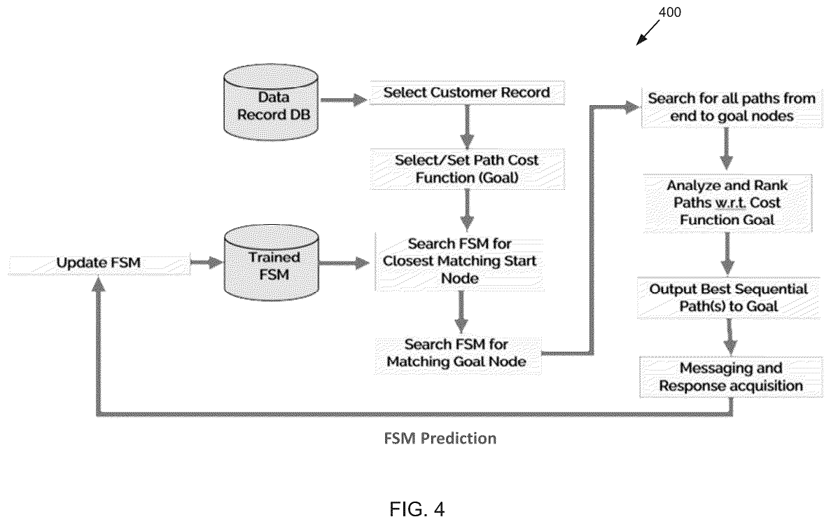

Referring again to FIG. 4, a diagram 400 showing an example temporal path to purchase FSM operational flow consistent with embodiments of recommendation process 10 is provided. FIG. 4 shows the operational flow for predicting optimal path(s) after FSM training. Path optimization goal parameters are first set (Note: this can be done dynamically for each customer or set of customers), after which the trained FSM is searched for the closest matching nodes to 1) the customer input and 2) the response goal node. As shown on the right, paths are evaluated per the selected optimization function, ranked, and then output for realization. Subsequent results are used as feedback data for updating the FSM to maintain its operational currency.

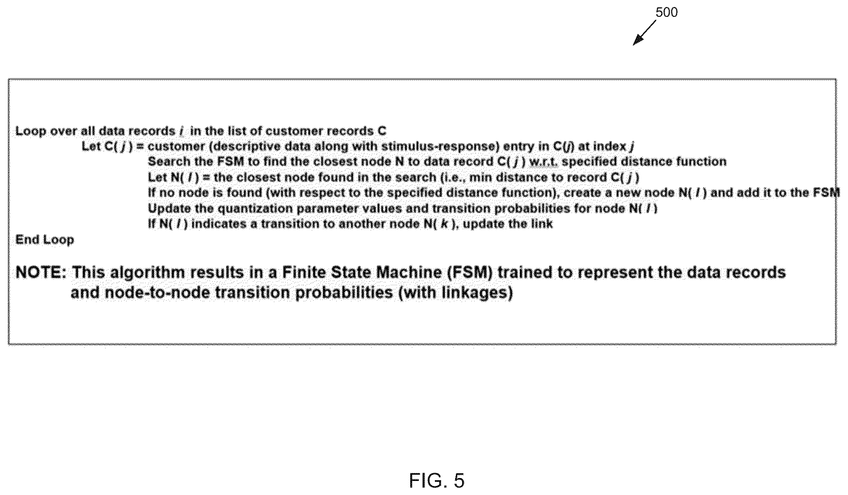

Referring again to FIG. 5, a diagram 500 showing an example temporal path to purchase FSM training algorithm consistent with embodiments of recommendation process 10 is provided. FIG. 5 shows the algorithmic flow wherein a loop over customer data is performed and 1) a search is performed to find the closest existing node, 2) create a new node if no matching node is found, 3) quantized parameter values and transition probabilities are updated, and 4) node linkages are updated.

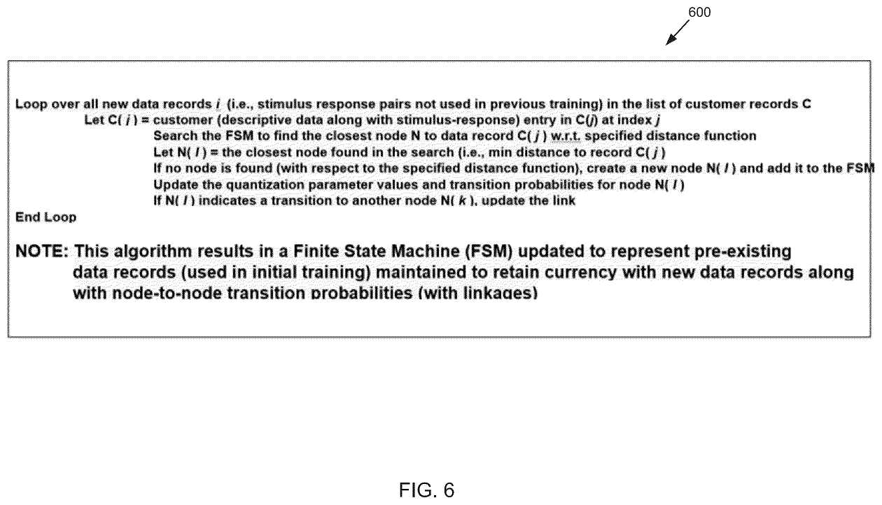

Referring again to FIG. 6, a diagram 600 showing an example temporal path to purchase FSM updating algorithm consistent with embodiments of recommendation process 10 is provided. FIG. 6 depicts the algorithmic FSM updating process where a previously trained FSM sequentially processes new customer data (e.g., new stimulus-response info for existing customer records) along with, 2) new customer records that may not have been used in initial training or previous update processes.

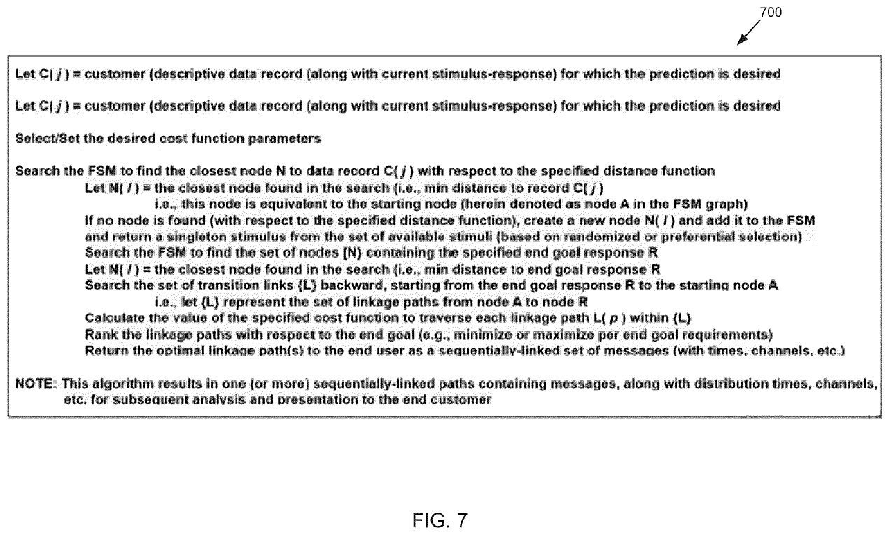

Referring again to FIG. 7, a diagram 700 showing an example temporal path to purchase FSM prediction algorithm consistent with embodiments of recommendation process 10 is provided. FIG. 7 shows the algorithmic process flow for predicting optimal paths using a previously trained FSM. After optimization cost function and auxiliary parameters are set, a search over existing FSM nodes is performed to 1) find the closest node to the input customer record node (e.g., node “A”), 2) find the selected end response goal (e.g., node “R”), 3) identify the linked path(s) between the starting node “A” and end response node “R”, 4) calculate and rank the cost function for each linked transition path, 5) return the optimal path(s) to the user for subsequent use, review, and analysis.

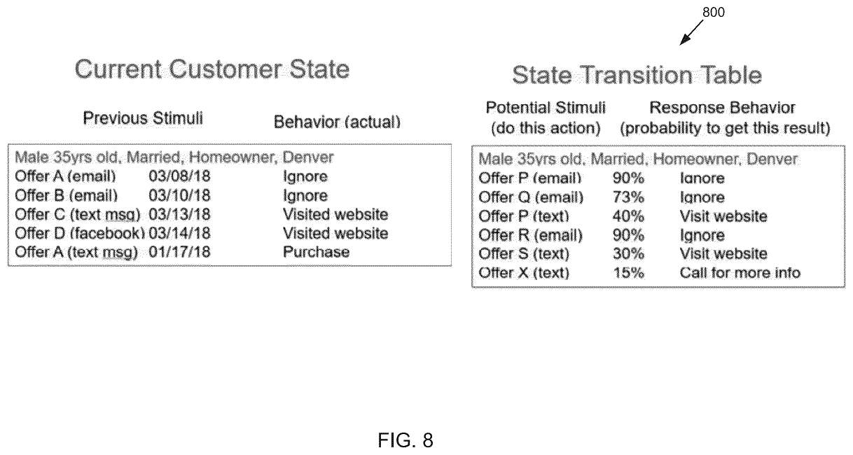

Referring again to FIG. 8, a diagram 800 showing an example temporal path to purchase FSM consistent with embodiments of recommendation process 10 is provided. This example shows a current customer state and a state transition table. Within the current customer state, a previous stimuli and behavior (actual) is provided. The state transition table includes both potential stimuli and response behavior. In this figure, customer state info includes both demographic data and behavioral (time-date) stimulus-response information. The state-transition table depicts an example of stimuli (e.g., type, content, and channel) and probabilities for various responses (e.g., ignore msg, visit website).

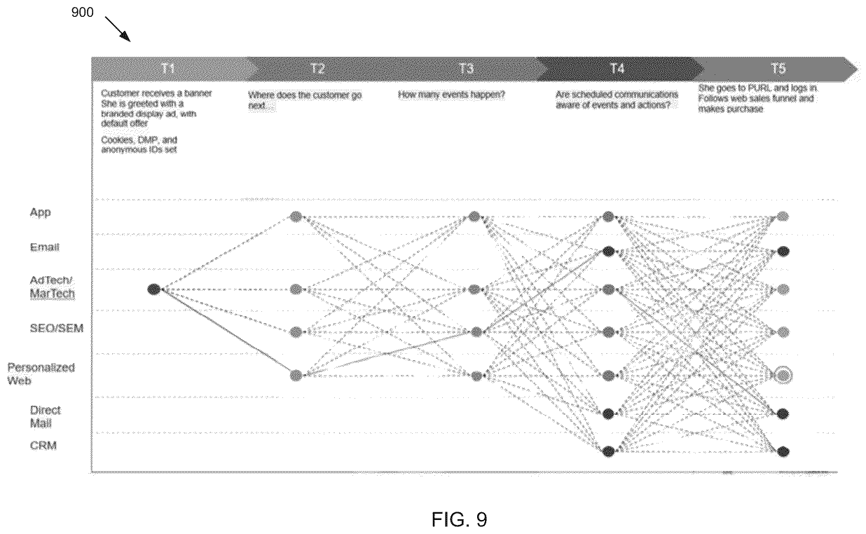

Referring again to FIG. 9, a diagram 900 showing an example depicting unmanaged paths including all potential paths consistent with embodiments of recommendation process 10 is provided. Depicted in FIG. 9 are potential temporally-linked paths via different marketing channels for a customer.

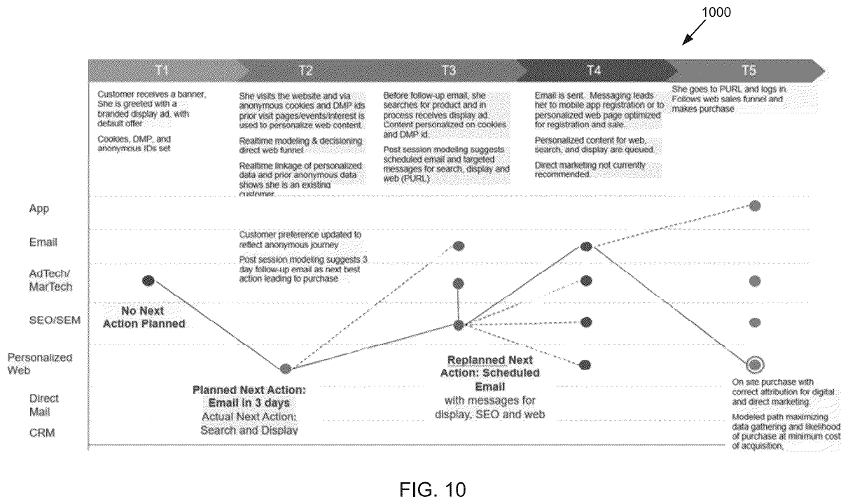

Referring again to FIG. 10, a diagram 1000 showing an example temporal path to purchase with an optimized temporal sequence consistent with embodiments of recommendation process 10 is provided. Depicted in FIG. 10 is a selected, actionable path for the customer, showing channels used at each step in the temporal sequence of messaging events.

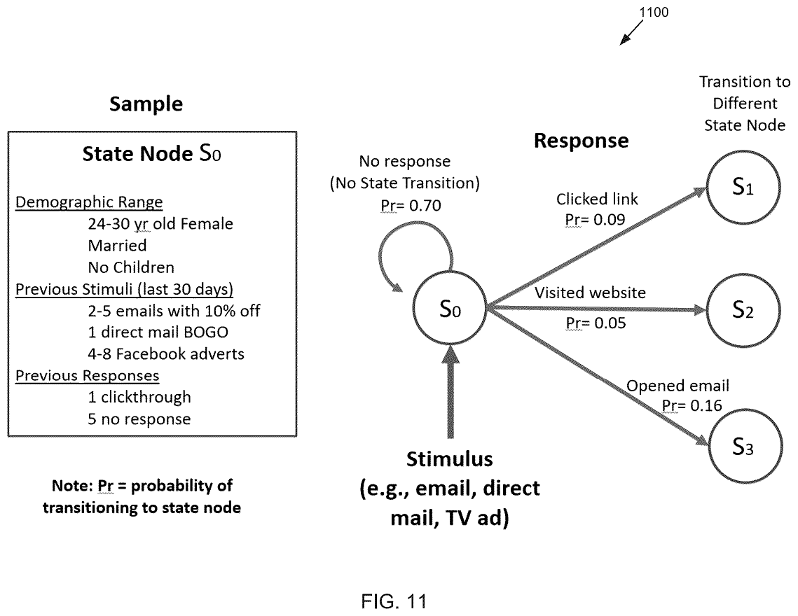

Referring again to FIG. 11, a diagram 1100 showing an example FSM state node stimulus consistent with embodiments of recommendation process 10 is provided. Diagram 1100 shows an example of response transitioning consistent with embodiments of recommendation process 10. At the left in FIG. 11 is shown an example of the information contained in a FSM state node containing quantized demographic and behavioral stimulus-response pair information. At the right in FIG. 11, node transitions with probabilities are shown for incoming stimuli. Note that presentation of the stimulus may result in either a transition to another node, or no transition (i.e., self-referential transition).

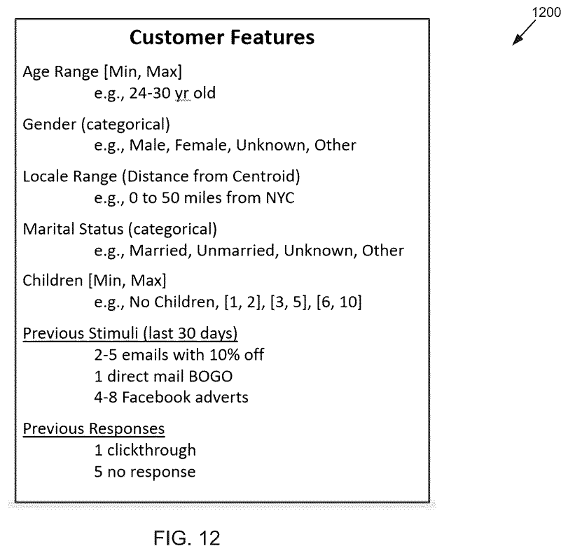

Referring again to FIG. 12, a diagram 1200 showing an example of FSM state node feature quantization equivalency consistent with embodiments of recommendation process 10 is provided. Diagram 1200 shows an example of a sample feature space. FIG. 12 depicts a customer record schema that contains a combination of demographic information together with historical stimulus-response data.

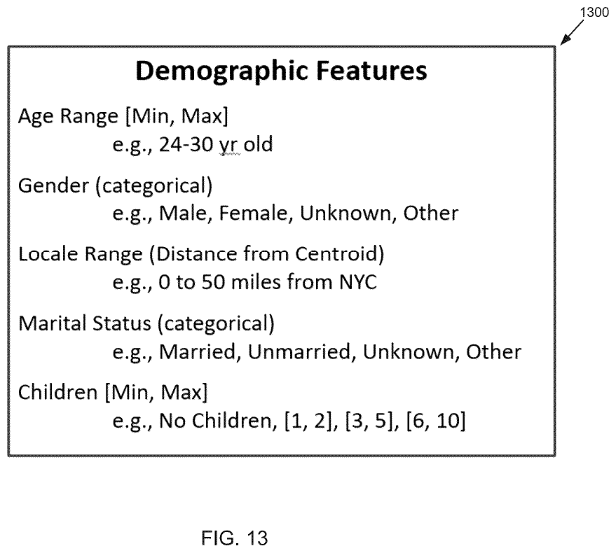

Referring again to FIG. 13, a diagram 1300 showing an example of FSM state node demographic feature quantization equivalency consistent with embodiments of recommendation process 10 is provided. Diagram 1300 shows an example of a sample demographic feature space. Shown in FIG. 13 is example demographic information customer record with data types and their associated quantization ranges.

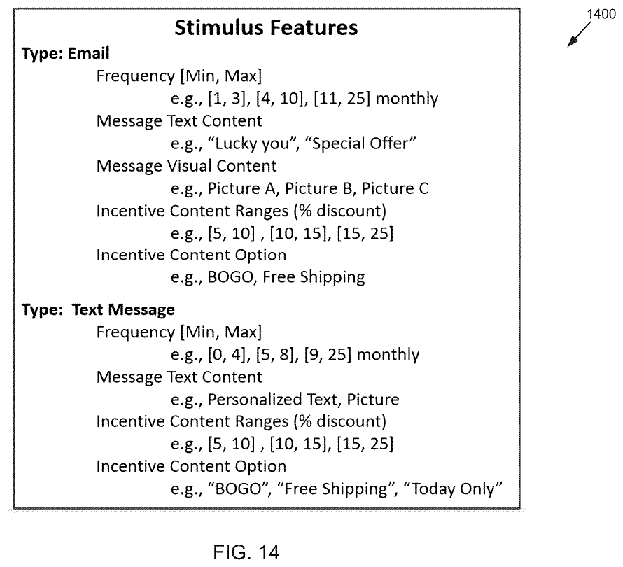

Referring again to FIG. 14, a diagram 1400 showing an example of FSM state node stimulus feature quantization equivalency consistent with embodiments of recommendation process 10 is provided. Diagram 1400 shows an example of a sample stimulus feature space. S Example stimulus features in FIG. 14 are partitioned by stimulus type (e.g., email, text message) indicating each type may incorporate different features, quantization criteria, and content parameters.

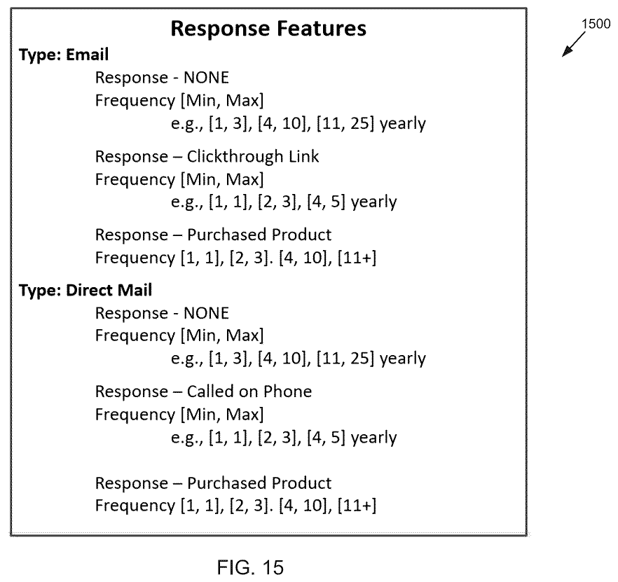

Referring again to FIG. 15, a diagram 1500 showing an example of FSM state node response feature quantization equivalency consistent with embodiments of recommendation process 10 is provided. Diagram 1500 shows an example of a sample response feature space. Example response features in FIG. 15 are partitioned by associated stimulus type (e.g., email, text message). FIG. 15 depicts the case wherein responses are type-dependent (i.e., by their associated stimulus type), and may incorporate different response features and/or response frequency quantization criteria (e.g., the possible response set for direct mail stimuli may not include a website click-through case).

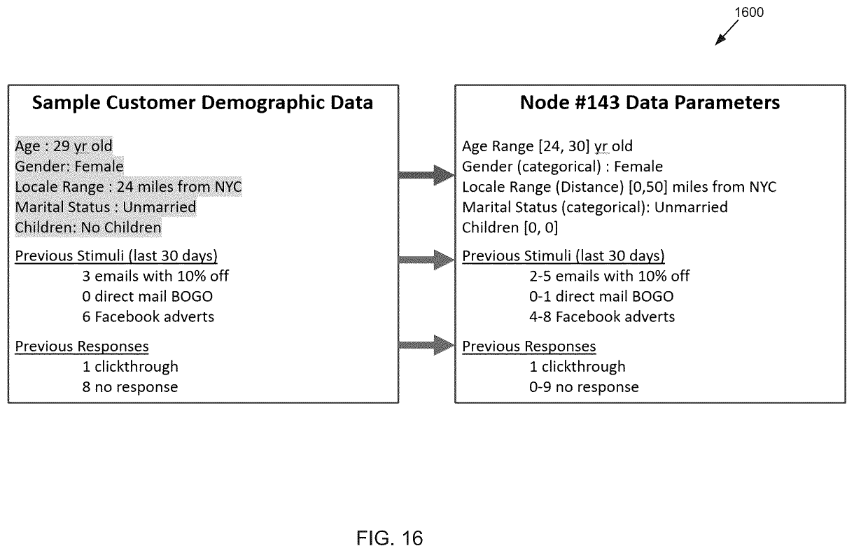

Referring again to FIG. 16, a diagram 1600 showing an example customer to FSM node demographic mapping consistent with embodiments of recommendation process 10 is provided. Diagram 1600 shows an example of sample customer demographic data and specific node data parameters. In FIG. 16, the example ‘raw’ customer demographic data is mapped into a node with associated quantized demographic variables (e.g., customer age 29 years maps into this node with age range bounds between 24 and 30 years. Note that all customer variables map directly and uniquely into an existing node. In cases where no match can be found in the FSM, a new node is created to represent this customer data.

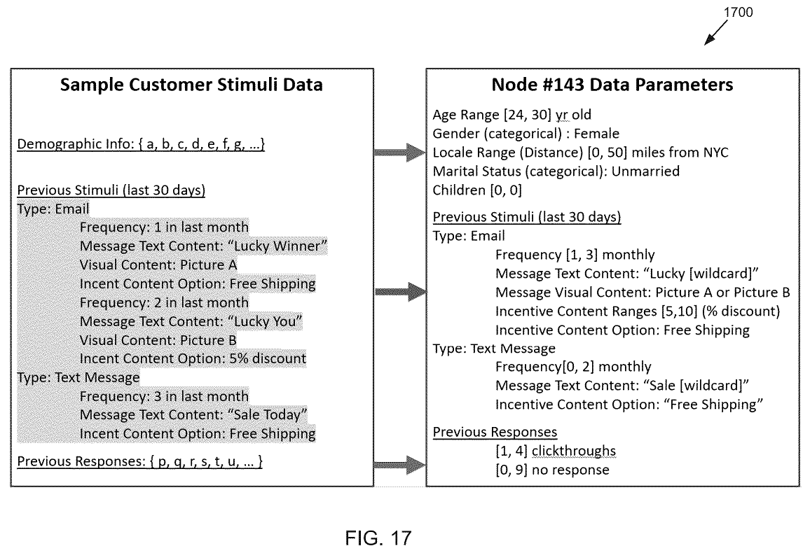

Referring again to FIG. 17, a diagram 1700 showing an example of customer to FSM node stimulus mapping consistent with embodiments of recommendation process 10 is provided. Diagram 1700 shows an example of sample customer stimuli data and data parameters of a particular node. In FIG. 17, the example ‘raw’ customer stimulus data is mapped into a node with associated quantized stimulus variables (e.g., email, content frequency, text, visual and incentive content. In this example the email with frequency 1 (per month), text “Lucky winner”, visual consisting of Picture A, and optional incentive set to “Free Shipping” maps into the quantized equivalents of node #143.

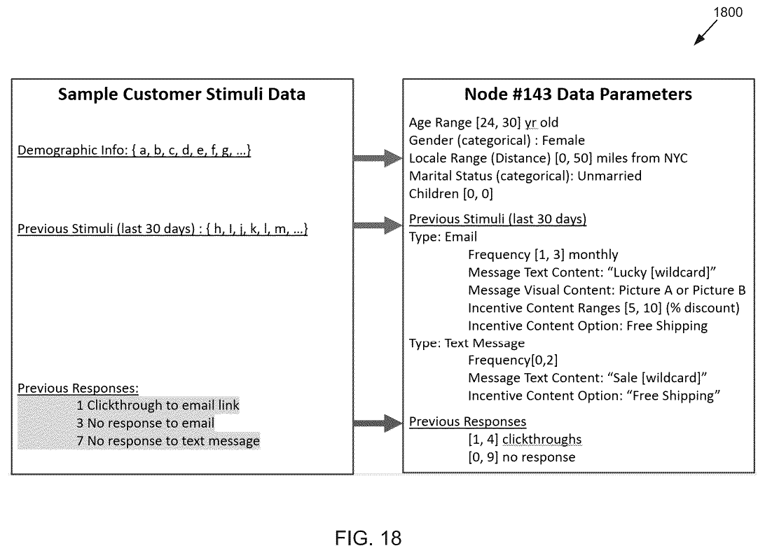

Referring again to FIG. 18, a diagram 1800 showing an example of customer to FSM node response mapping consistent with embodiments of recommendation process 10 is provided. Diagram 1800 shows an example of sample customer stimuli data and data parameters of a particular node. In FIG. 18, the example ‘raw’ historical customer response data (e.g., 7 “no responses” to text messages) maps into the quantized equivalents (e.g., anything in the range of zero to 9) of node #143.

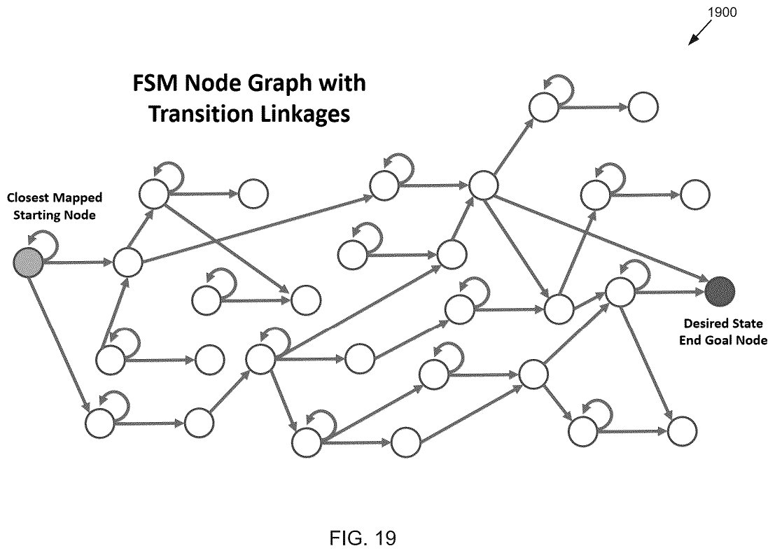

Referring again to FIG. 19, a diagram 1900 showing an example FSM node graph with transition linkages consistent with embodiments of recommendation process 10 is provided. Diagram 1900 shows an example depicting a closest mapped starting node and a desired state end goal node. FIG. 19 shows all paths emanating from the starting node that ending at various terminal nodes. A potential desired end goal is shown on the right portion of the diagram. In this example only a subset of the paths connect both starting and desired end node.

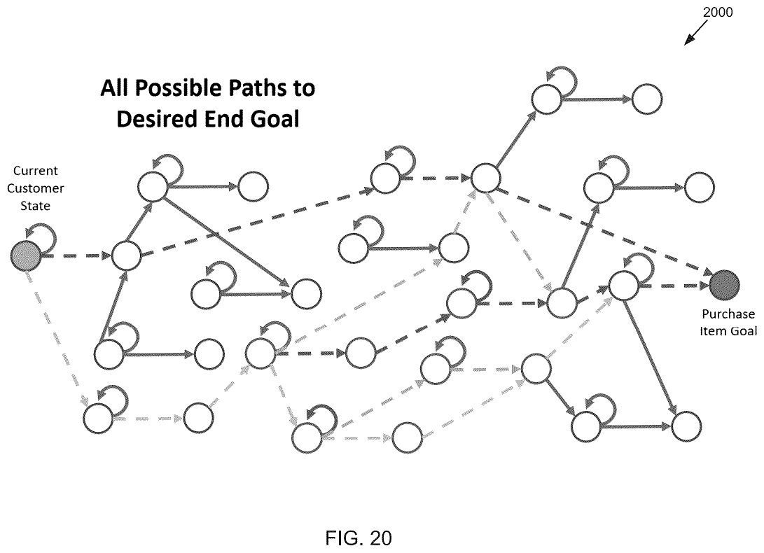

Referring again to FIG. 20, a diagram 2000 showing an example depicting all possible paths to desired end goal consistent with embodiments of recommendation process 10 is provided. Diagram 2000 shows an example depicting a current customer state and a purchase item goal. FIG. 20 shows all paths emanating from the starting node, all paths terminating at the end (“purchased item” goal) node, wherein a subset of the paths (indicated by the dashed lines) connect both starting and ending nodes.

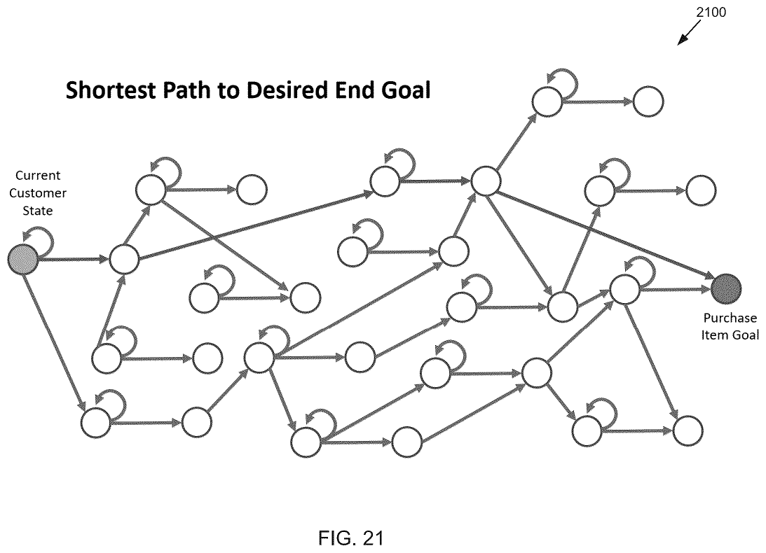

Referring again to FIG. 21, a diagram 2100 showing an example depicting the shortest path to a desired end goal consistent with embodiments of recommendation process 10 is provided. Diagram 2100 shows an example depicting a current customer state and a purchase item goal. FIG. 21 shows the shortest length path (i.e., number of node links) between the starting node and terminating at the end (“purchased item” goal) node.

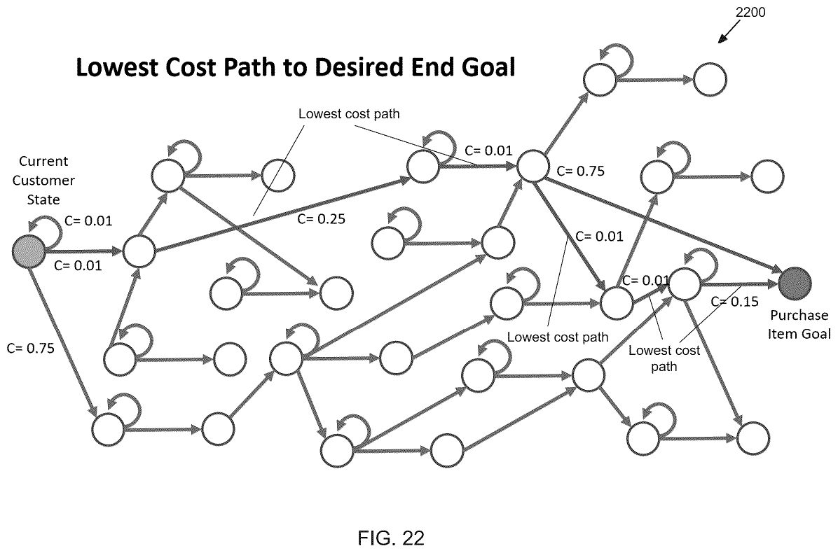

Referring again to FIG. 22, a diagram 2200 showing an example depicting the lowest cost path to a desired end goal consistent with embodiments of recommendation process 10 is provided. Diagram 2200 shows an example depicting a current customer state and a purchase item goal. FIG. 22 shows the links depicting the lowest cost path (e.g., sum of calculated stimulus transition costs) between the starting node and terminating at the end (“purchased item” goal) node. Note that while there are other paths connecting the starting and ending goal nodes, the links shown represent the lowest cost transition path.

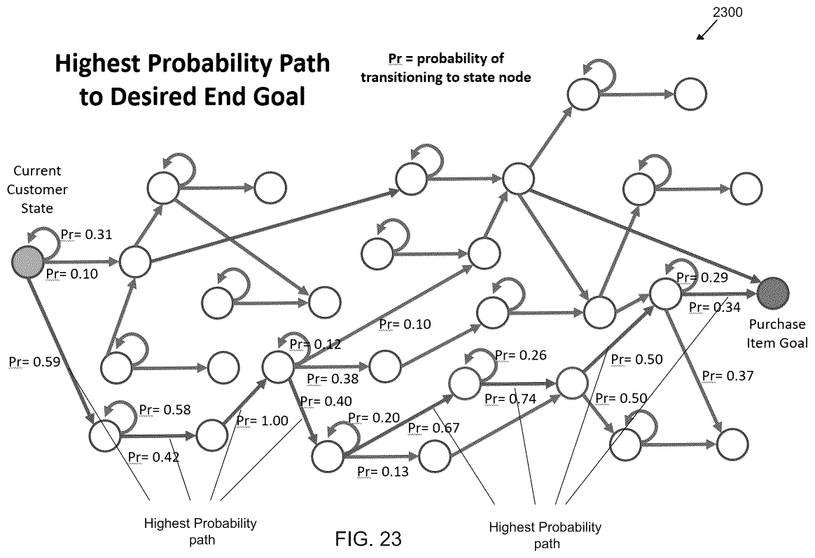

Referring again to FIG. 23, a diagram 2300 showing an example depicting the highest probability path to a desired end goal consistent with embodiments of recommendation process 10 is provided. Diagram 2300 shows an example depicting a current customer state and a purchase item goal. FIG. 23 shows the links depicting the highest probability path (e.g., sum of calculated stimulus transition probabilities) between the starting node and terminating at the purple end (“purchased item” goal) node. Note that while there are other paths connecting the starting and ending goal nodes, the links shown represent the highest probability of successful transition path.

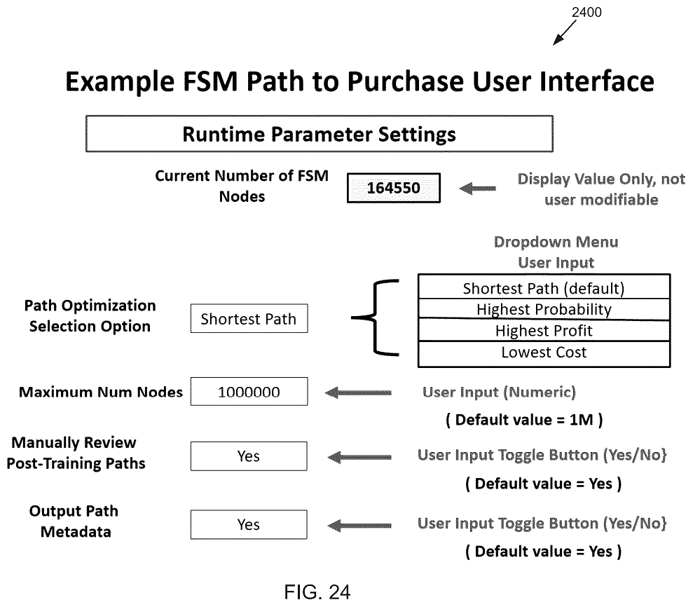

Referring again to FIG. 24, a diagram 2400 showing an example FSM path to purchase user interface consistent with embodiments of recommendation process 10 is provided. Graphical user interface 2400 shows an example depicting runtime parameter settings. The UI depicts user-controlled variable inputs for path optimization methodology, maximum number of nodes to allow in the FSM, and options for post-training output and manual review/analysis.

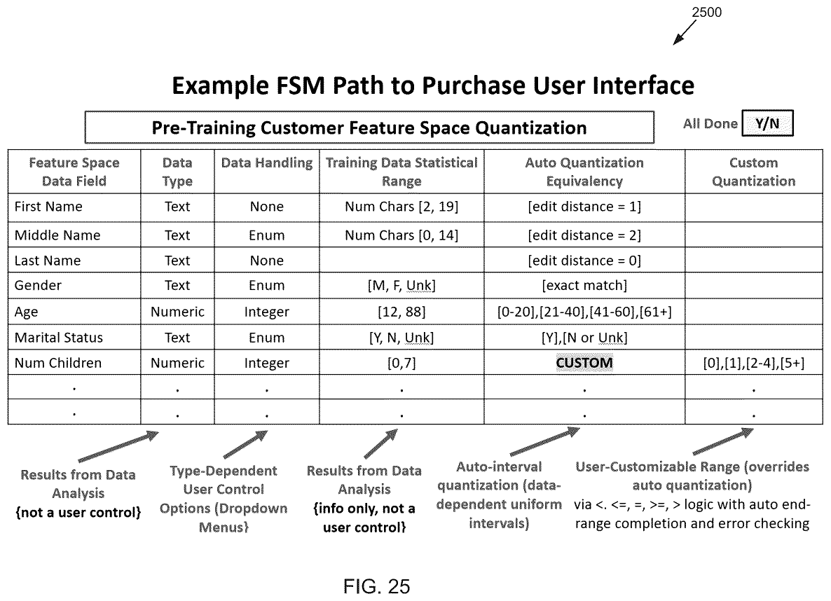

Referring again to FIG. 25, a diagram 2500 showing an example FSM path to purchase user interface consistent with embodiments of recommendation process 10 is provided. Graphical user interface 2500 shows an example depicting pre-training customer feature space quantization. FIG. 25 is an example of a user interface for customer feature space control that shows 1) names of input features (automatically populated from the data source(s), 2) data types for each field, 3) options for special handling (e.g., enumerate text fields into integers), 3) statistical information for the customer feature field (e.g., min-max range), 4) automated default quantization ranges (i.e., suggestions), and 5) customizable quantization (option) range inputs, allowing user capability to override automated default settings for each field.

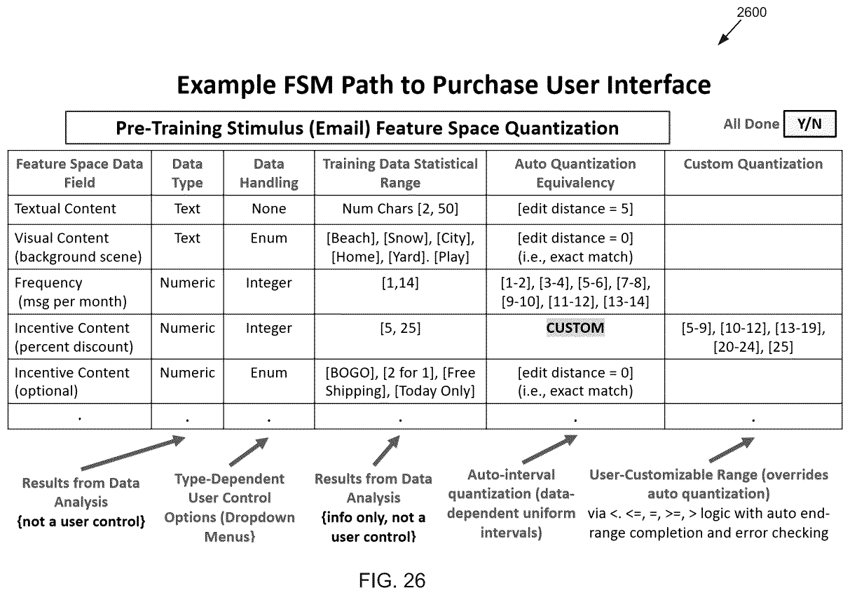

Referring again to FIG. 26, a diagram 2600 showing an example FSM path to purchase user interface consistent with embodiments of recommendation process 10 is provided. Graphical user interface 2600 shows an example depicting pre-training stimulus (email) feature space quantization. FIG. 26 is an example of a user interface for (email messaging) stimulus feature space control that shows 1) names of stimulus variables (automatically populated from the data source(s), 2) data types for each field, 3) options for special handling (e.g., enumerate text fields into integers), 3) statistical information for the stimulus feature field (e.g., min-max range), 4) automated default quantization ranges (i.e., suggestions), and 5) customizable quantization (option) range inputs, allowing user capability to override automated default settings for each field. Note that in this example, stimulus feature space features pertain specifically to email stimuli which may be different from other messaging channels.

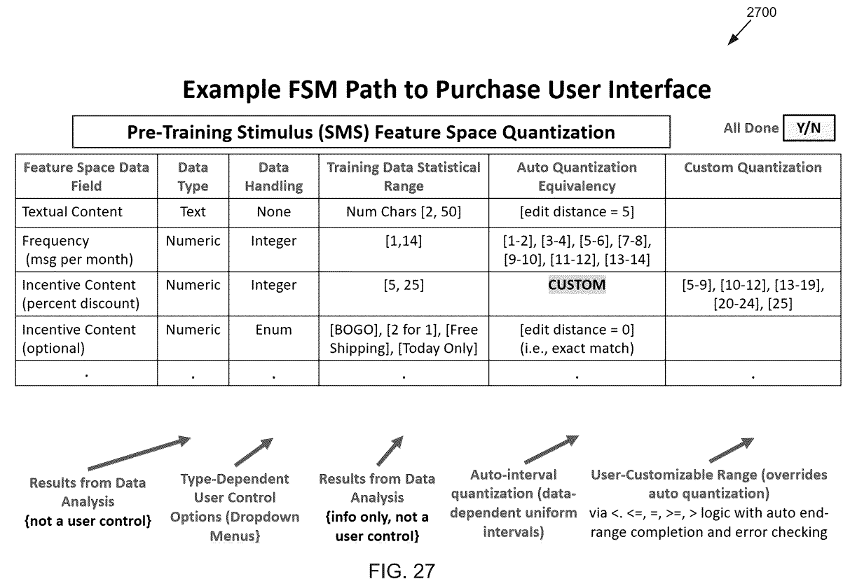

Referring again to FIG. 27, a diagram 2700 showing an example FSM path to purchase user interface consistent with embodiments of recommendation process 10 is provided. Graphical user interface 2700 shows an example depicting pre-training stimulus (SMS) feature space quantization. FIG. 27 is an example of a user interface for (SMS messaging) stimulus feature space control that shows 1) names of SMS stimulus variables (automatically populated from the data source(s), 2) data types for each field, 3) options for special handling (e.g., enumerate text fields into integers), 3) statistical information for the stimulus feature field (e.g., min-max range), 4) automated default quantization ranges (i.e., suggestions), and 5) customizable quantization (option) range inputs, allowing user capability to override automated default settings for each field. Note that in this example, stimulus feature space features pertain specifically to SMS stimuli which may be different from other messaging channels.

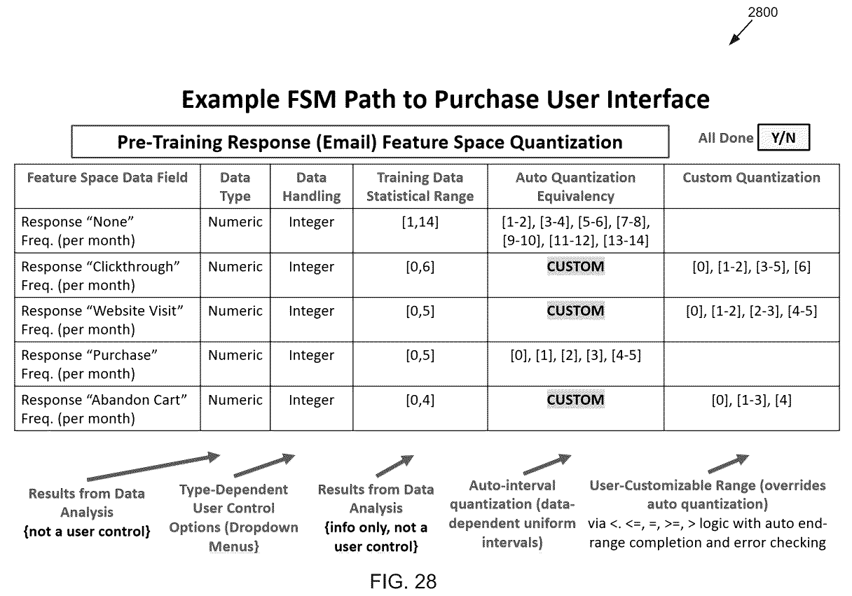

Referring again to FIG. 28, a diagram 2800 showing an example FSM path to purchase user interface consistent with embodiments of recommendation process 10 is provided. Graphical user interface 2800 shows an example depicting pre-training response (email) feature space quantization. FIG. 28 is an example of a user interface for response (i.e., responses to email stimuli) feature space control that shows 1) names of response variables (automatically populated from the data source(s), 2) data types for each field. 3) options for special handling (e.g., enumerate text fields into integers), 3) statistical information for the response feature field (e.g., min-max range), 4) automated default quantization ranges (i.e., suggestions), and 5) customizable quantization (option) range inputs, allowing user capability to override automated default settings for each field. Note that in this example, response feature space features pertain specifically to responses to email stimuli which may be different from response information from other messaging channels.

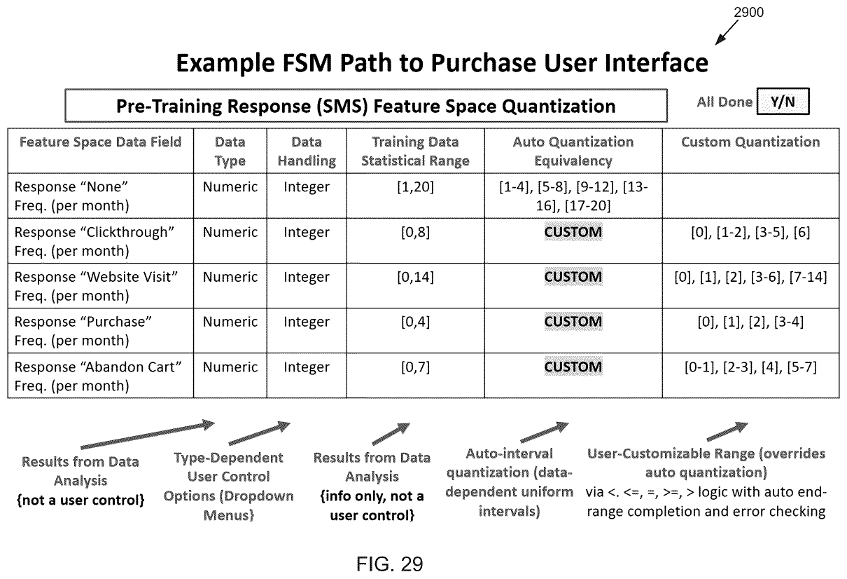

Referring again to FIG. 29, a diagram 2900 showing an example FSM path to purchase user interface consistent with embodiments of recommendation process 10 is provided. Graphical user interface 2900 shows an example depicting pre-training response (SMS) feature space quantization. FIG. 29 is an example of a user interface for response (i.e., responses to SMS stimuli) feature space control that shows 1) names of response variables (automatically populated from the data source(s), 2) data types for each field, 3) options for special handling (e.g., enumerate text fields into integers), 3) statistical information for the response feature field (e.g., min-max range), 4) automated default quantization ranges (i.e., suggestions), and 5) customizable quantization (option) range inputs, allowing user capability to override automated default settings for each field. Note that in this example, response feature space features pertain specifically to responses to SMS stimuli which may be different from response information from other messaging channels.

It will be apparent to those skilled in the art that various modifications and variations can be made to recommendation process 10 and/or embodiments of the present disclosure without departing from the spirit or scope of the invention. Thus, it is intended that embodiments of the present disclosure cover the modifications and variations of this invention provided they come within the scope of the appended claims and their equivalents.

What is claimed is:

1. A finite state machine based temporal path to purchase customer marketing method, comprising:
generating, using a processor, a plurality of customer focused stimuli, wherein the stimuli includes messaging content information, delivery mechanism information, delivery time and frequency information, and message presentation frequency;
transmitting the plurality of customer focused stimuli to a customer computing device;
receiving customer response data in response to the plurality of customer focused stimuli;
performing response quantization operations on the customer response data within a finite state machine to generate a temporal sequence of personalized customer recommendations.

2. The finite state machine based temporal path to purchase customer marketing method of claim 1, wherein the finite state machine includes a training phase.

3. The finite state machine based temporal path to purchase customer marketing method of claim 1, wherein the finite state machine includes an updating phase.

4. The finite state machine based temporal path to purchase customer marketing method of claim 1, wherein the finite state machine includes a prediction phase.

5. The finite state machine based temporal path to purchase customer marketing method of claim 1, wherein each of the plurality of customer focused stimuli are transmitted at different timepoints.

6. The finite state machine based temporal path to purchase customer marketing method of claim 5, wherein the customer response data is received at different timepoints.

7. The finite state machine based temporal path to purchase customer marketing method of claim 1, wherein the finite state machine receives a desired end goal as an input from a business entity.

8. A non-transitory computer readable storage medium having stored thereon instructions, which when executed by a processor result in one or more finite state machine based temporal path to purchase customer marketing operations, the operations comprising:
generating, using a processor, a plurality of customer focused stimuli, wherein the stimuli includes messaging content information, delivery mechanism information, delivery time and frequency information, and message presentation frequency;
transmitting the plurality of customer focused stimuli to a customer computing device;
receiving customer response data in response to the plurality of customer focused stimuli;
performing response quantization operations on the customer response data within a finite state machine to generate a temporal sequence of personalized customer recommendations.

9. The non-transitory computer readable storage medium of claim 8, wherein the finite state machine includes a training phase.

10. The non-transitory computer readable storage medium of claim 8, wherein the finite state machine includes an updating phase.

11. The non-transitory computer readable storage medium of claim 8, wherein the finite state machine includes a prediction phase.

12. The non-transitory computer readable storage medium of claim 8, wherein each of the plurality of customer focused stimuli are transmitted at different timepoints.

13. The non-transitory computer readable storage medium of claim 8, wherein the customer response data is received at different timepoints.

14. The non-transitory computer readable storage medium of claim 8, wherein the finite state machine receives a desired end goal as an input from a business entity.

15. A system for finite state machine based temporal path to purchase customer marketing comprising a computing device having at least one processor and a memory, wherein the at least one processor is configured to:
generate, using a processor, a plurality of customer focused stimuli, wherein the stimuli includes messaging content information, delivery mechanism information, delivery time and frequency information, and message presentation frequency;
transmit the plurality of customer focused stimuli to a customer computing device;
receive customer response data in response to the plurality of customer focused stimuli;
perform response quantization operations on the customer response data within a finite state machine to generate a temporal sequence of personalized customer recommendations.

16. The system of claim 15, wherein the finite state machine includes a training phase.

17. The system of claim 15, wherein the finite state machine includes an updating phase.

18. The system of claim 15, wherein the finite state machine includes a prediction phase.

19. The system of claim 15, wherein each of the plurality of customer focused stimuli are transmitted at different timepoints.

20. The system of claim 15, wherein the customer response data is received at different timepoints.
